(19) United States
(12) Patent Application Publication
(10) Pub. No.: US 2025/0369756 A1
(43) Pub. Date: Dec. 4, 2025

(54) SHIPPING CENTER MONITORING APPARATUS AND METHOD OF USE THEREOF

(71) Applicants: James W. Haywood, Boerne, TX (US); W. Davis Lee, Rockport, ME (US); Mark Amato, S. Hamilton, MA (US)

(72) Inventors: James W. Haywood, Boerne, TX (US); W. Davis Lee, Rockport, ME (US); Mark Amato, S. Hamilton, MA (US)

(21) Appl. No.: 18/759,946

(22) Filed: Jun. 30, 2024

Related U.S. Application Data
(63) Continuation-in-part of application No. 18/676,808, filed on May 29, 2024.

(51) Int. Cl. G01C 13/00; G01W 1/04

(52) U.S. Cl. CPC G01C 13/002; G01W 1/04

(57) ABSTRACT

The invention comprises an apparatus and method of use thereof for measuring state of a shipping center, the shipping center comprising a body of water and a set of bollards positioned in the water, the apparatus comprising: a main controller and a sensor array communicatively linked to the main controller, the sensor array comprising: a set of at least fifty sensor clusters, individual members of the set of at least fifty sensor clusters respectively mounted on a set of at least fifty bollards of the set of bollards, wherein each member of the set of at least fifty bollards comprises separate water surrounded positions in the shipping center, the shipping center comprising a radius of less than one hundred miles, the sensor cluster comprising: an inclinometer, an accelerometer, a water current sensor, a camera, a temperature sensor, and/or an anemometer.

### CROSS-REFERENCES TO RELATED APPLICATIONS

This application is a continuation-in-part of U.S. patent application Ser. No. 18/676,808 filed May 29, 2024.

### BACKGROUND OF THE INVENTION

### Field of the Invention

The invention relates generally to monitoring a body of water, such as a port facility.

### Discussion of the Prior Art

### Problem

There exists in the art a need for a body of water, such as a port.

### SUMMARY OF THE INVENTION

The invention comprises a port monitoring apparatus and method of use thereof.

### DESCRIPTION OF THE FIGURES

A more complete understanding of the present invention is derived by referring to the detailed description and claims when considered in connection with the Figures, wherein like reference numbers refer to similar items throughout the Figures.

FIG. 1 illustrates a control system using a sensor array;

FIG. 2A illustrates a shipping center sensor array, a controller, and bollards; FIG. 2B illustrates a sensor array attached to a bollard; and FIG. 2C and FIG. 2D illustrate sensor arrays strapped to a bollard from a side view and from a top view, respectively;

FIG. 3 illustrates power sources;

FIG. 4 illustrates communication systems;

FIG. 5A illustrates multiple sensor arrays;

FIG. 5B illustrates sensor types;

FIG. 5C illustrates sensor clusters;

FIG. 6 illustrates communication linkages; and

FIG. 7 illustrates multiple sensor lines monitoring an area.

Elements and steps in the figures are illustrated for simplicity and clarity and have not necessarily been rendered according to any particular sequence. For example, steps that are performed concurrently or in different order are illustrated in the figures to help improve understanding of embodiments of the present invention.

### DETAILED DESCRIPTION OF THE INVENTION

The invention comprises an apparatus and method of use thereof for measuring state of a shipping center, the shipping center comprising a body of water and a set of bollards positioned in the water, the apparatus comprising: a main controller and a sensor array communicatively linked to the main controller, the sensor array comprising: a set of at least fifty sensor clusters, individual members of the set of at least fifty sensor clusters respectively mounted on a set of at least fifty bollards of the set of bollards, wherein each member of the set of at least fifty bollards comprises separate water surrounded positions in the shipping center, the shipping center comprising a radius of less than one hundred miles, the sensor cluster comprising: an inclinometer, an accelerometer, a water current sensor, a camera, a temperature sensor, and/or an anemometer.

Herein, a z-axis is aligned with gravity and an x/y-plane is perpendicular to the z-axis, such as flat ground.

Herein, a standalone post mounted in water is referred to as a bollard. Types of bollards, include: (1) a marine bollard, which is a bollard mounted as a standalone pole in water, such as fresh water or salt water and (2) a dock bollard, which is a bollard attached to a dock.

### Monitoring System

Generally a monitoring system monitors one or more sensors/sensor clusters of a set of sensor arrays to determine the state of a system and/or a state of a system sub-system or component. For instance, the monitoring system optionally and preferably monitors elements of a shipping center, docking center, and/or port, such as a bollard.

Herein, for clarity of presentation and without loss of generality, a shipping center monitoring system is used to monitor a shipping location, where a shipping location refers to a shipping port, shipping marina, marine terminal, offshore loading dock, and/or docking center, in a port, in an offshore docking location, in a coastal inland waterway, and/or in a canal, such as in fresh water, brackish water, and/or in salt water.

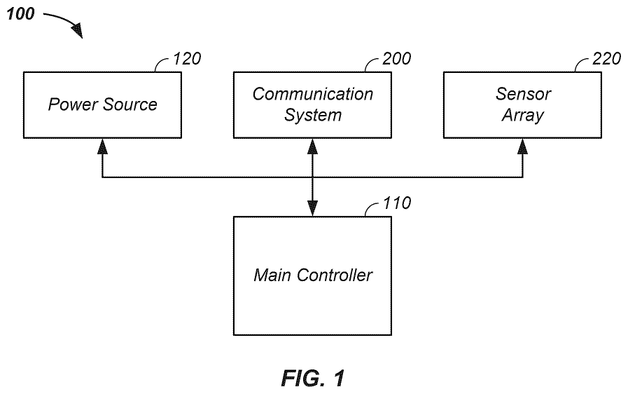

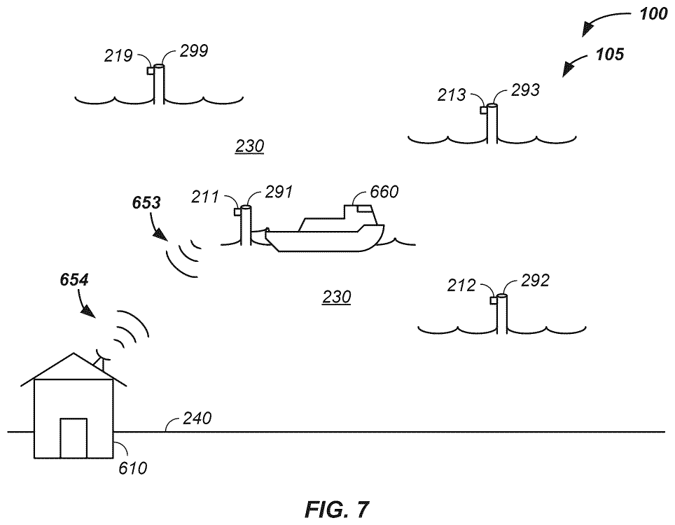

Referring now to FIG. 1 and FIG. 7, a first example of a shipping center monitoring system 100 of a shipping center 105 is illustrated. Generally, a main controller 110, a communication system 200, and/or a sensor array 220 is powered with one or more power sources 120. The main controller 110 communicates using the communication system 200 with one or more sensors/sensor clusters in one or more sensor arrays 220, where the one or more sensor arrays are optionally and preferably attached to bollards/floating docks, as further described, infra.

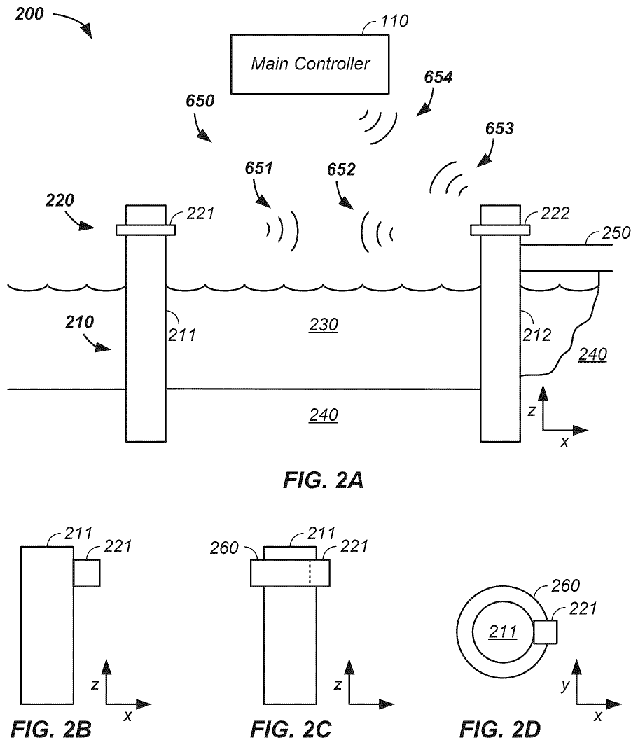

Referring now to FIG. 2A, the communication system 200 is further described and bollards and communication collars are described. Herein, for clarity of presentation and without loss of generalization, sensor clusters attached to bollards are described. However, the sensor cluster elements of the sensor array 220 are optionally indirectly attached to the bollards and/or are optionally attached to any element of the shipping center that could be adversely affected by being hit by a boat/ship and/or the weather. For instance, the sensor cluster elements of the sensor array 220 are optionally attached to a floating element of the shipping center, such as a dock or floating offloading facility, and/or a rigid fixed element such as a non-floating dock and/or an offloading facility element, such as a floor.

Still referring to FIG. 2A, generally, a set of bollards 210 are deployed in a body of water 230, such as in a shipping center and/or in a port, where the set of bollards comprises n bollards, where n is a positive integer greater than 1, 5, 10, 50, 100, 500, or 1000. An exemplary first bollard 211 and an exemplary second bollard 212, of the set of bollards 210, are illustrated, which are examples of a standalone bollard and a dock bollard, respectively. The first bollard 211 is illustrated as having been driven/installed through water 230 into ground 240/waterway floor/ocean floor. In use, a ship would tie off to the first bollard 211 and/or the second bollard 212, as further illustrated infra. The second bollard 212 is illustrated as being part of a dock 250, unloading facility, and/or a ground element of a port facility.

Still referring to FIG. 2A, a set of sensor arrays 220 is illustrated, where the set of sensor arrays comprise n arrays or n sensor clusters, where n is a positive integer greater than 1, 5, 10, 50, 100, or 500. A first sensor cluster 221 attached to the first bollard 211 and a second sensor cluster 222 attached to the second bollard 212, of the set of sensor arrays 220, are illustrated, which are examples of sensors attached to a standalone bollard and a dock bollard, respectively.

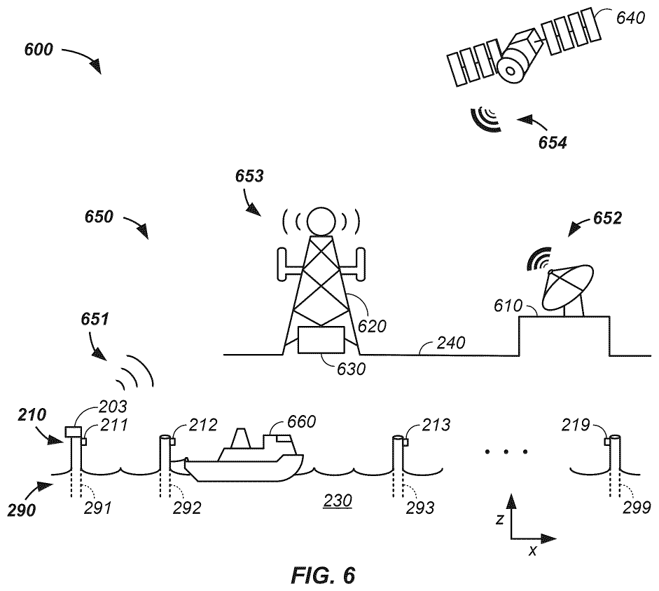

Still referring to FIG. 2A, a transmitter and/or a receiver is optionally and preferably present with each, a majority, and/or at least 2, 5, 10, 50, or 100 of installation elements of corresponding sensor clusters of the array of sensors 220. Thus, the sensor clusters optionally and preferably communicate, such as through sending data collected from the sensors and/or information derived therefrom, with the main controller 110 through the communication system 200. Similarly, the main controller 110 optionally communicates, via use of the communication system 200, with the sensor array 220 and/or any element therein. As illustrated, the signals are sent 651 and/or received 652 between sensor clusters/sensor arrays on bollards of the set of bollards 210, such as, optionally and preferably, in a wireless communication system 650 and/or are transmitted from sensor clusters 653 directly and/or indirectly to the main controller 110 and/or received 654 by the main controller 110, or vice versa. Signals are optionally sent from sensor cluster to sensor cluster on separate bollards before sending the composite signals or processed signals to the main controller, as further described infra. For instance, optionally, one or more sub-communication systems 203 gather information from various sensors distributed on the members of the set of bollards 210 before transmitting to a local tower and/or to the main controller, as further described infra in the description of FIG. 6.

Referring now to FIGS. 2(B-D) mounting of the sensor clusters and/or housings thereof on the bollards is described. Generally, a bollard, such as a first bollard 211 has an associated sensor cluster, such as a first sensor cluster 221. The first sensor cluster 221 is optionally: affixed directly or indirectly to the first bollard 211, as illustrated in FIG. 2B, and/or is strapped to the first bollard 211, such as with a collar, strap, sensor cluster attachment element 260 as illustrated in FIG. 2B and FIG. 2C.

Referring again to FIG. 2A, elements of the sensor array 220, are optionally and preferably attached to separate bollards/shipping center elements. Sensors in the sensors clusters of the sensor array 220 are optionally and preferably designed to measure condition of the individual bollards at known locations, such as measured by GPS or placed at specific known locations during installation. For instance, GPS units are optionally respectively attached to members of the set of bollards 210. Hence, if the bollard moves, such as with tide, weather, being pulled by a ship, or by being struck by a ship, movement of the bollard is known. This is particularly important if the bollard is struck by a ship and the bollard is broken severely tipped/broken off. The data is particularly useful to determine the sequence of events of an accident in the shipping center 105, such as a ship crashing through bollards and hitting a dock or bridge. The data is optionally thus used in determination of cause of damages, such as for use in litigation or with insurance.

Still referring to FIG. 2A, optionally and preferably at least some elements of the sensor clusters in the sensor array 220, such as the bollard sensors, measure individual bollard states, such as through one or more of: movement of individual bollards, tilt/inclination of individual bollards, acceleration of individual bollards, and/or location of individual bollards as a function of time. Similarly, optionally and preferably at least some elements of the sensor clusters in the sensor array 220, such as the bollard sensors, measure conditions about the bollards, such as one or more of: temperature, atmospheric pressure, wind speed, current, rain, ice, fog, visibility, and/or salinity. Data from the sensors is optionally used to control the port facility, aid navigation, and/or aid a government agency like the National Oceanic and Atmospheric Administration (NOAA) and/or the National Weather Service (NWS).

Optionally and preferably, one or more cameras operating in the visible and/or near infrared wavelengths are mounted to one of more of the bollards and/or are mounted as elements of the sensor array 220. For instance, one or more sensors of a first set of sensors are included in a first cluster of sensors, where the one or more sensors comprise a first combination of any of the sensor types described herein. For example, the first combination of sensors are selected to measure state of the bollard. Similarly, one or more sensors of a second set of sensors are included in a second cluster of sensors, where the one or more sensors comprise a second combination of any of the sensor types described herein. For example, the second combination of sensors are selected to measure state of the environment about the bollard. A third cluster of sensors, installed on any number of bollards, includes sensor types from the first and second clusters. The infrared camera data is particularly useful for monitoring the waterway in foggy conditions and is thus optionally provided to ships in the area for navigational purposes.

Any of the data generated with the sensors described herein is optionally for sale.

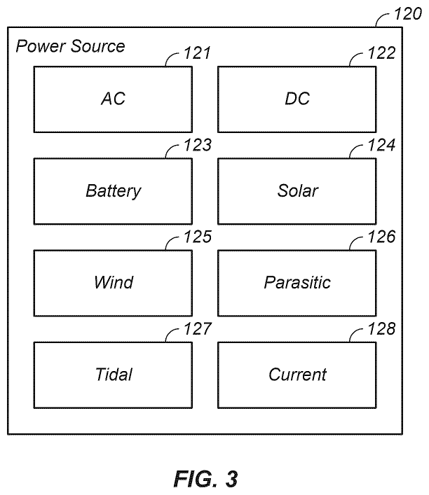

Referring now to FIG. 3, the power source 120 is further described. Optionally, the power source, linked to one or more of the individual sensors, cluster of sensors, the communication system 200, and/or the sensor arrays 220, includes one or more of: AC power 121, DC power 122, a converter, and inverter, a battery 123, solar power 124, wind derived power 125, parasitic power 126, such as pulled from a power line, tidal generated power 127, and/or current driven power 128, where any power source is electromechanically linked to any element of the sensor array 220.

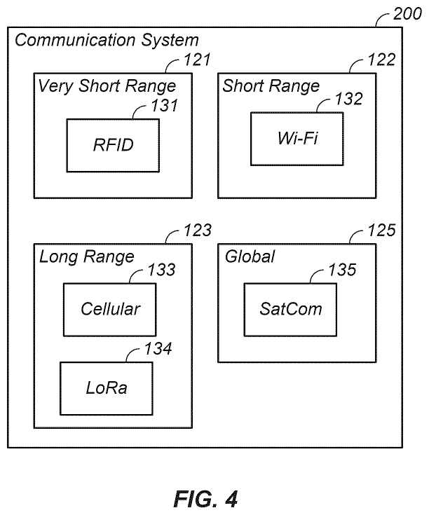

Referring now to FIG. 4, the communication system 200 is further described. The communication system 200 is optionally linked to any one or more element of the monitoring system 100, such as to individual sensors of the sensor arrays 220, any one or more poles of the bollards, any intermediate tower, and/or any intermediate communication network connected directly and/or indirectly to the main controller 110. The communication system 200 optionally and preferably includes one or more of: very short range communications 121, such as radio-frequency identification (RFID) communications 131; short range communications 122, such as Wi-Fi 132 or Bluetooth; long range communications 123, such as cellular 123 or long range radio (LoRa) 134; and/or global communications 124, such as satellite communications (SatCom) 135.

### Sensor Array

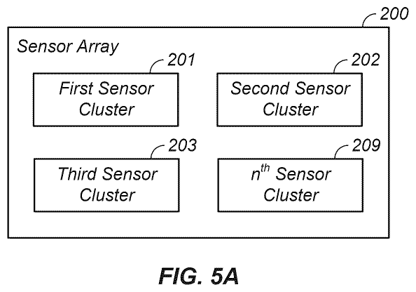

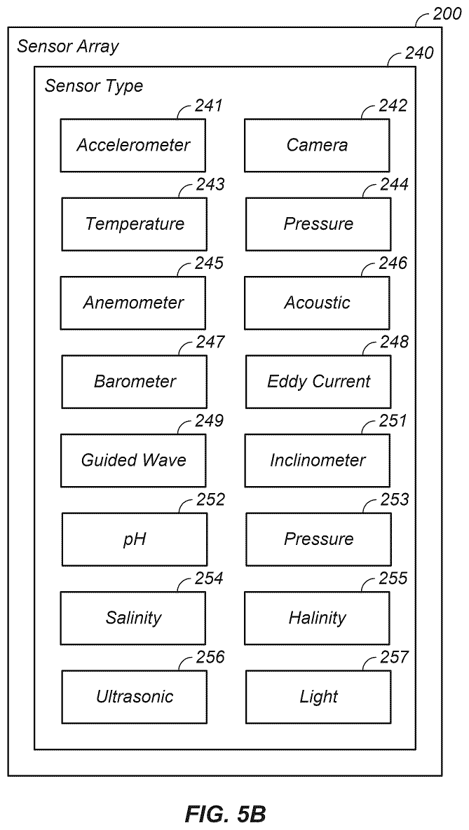

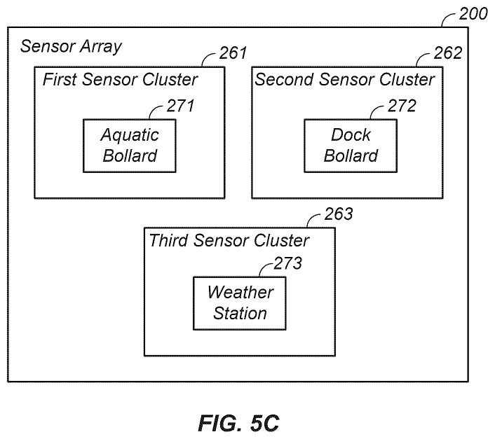

Referring now to FIG. 5A, FIG. 5B, and FIG. 5C, the sensor array 220 is further described. Referring now to FIG. 5A, the sensor array 220 preferably includes 2, 3, 4, or more individual sensor clusters, clusters of sensor, or arrays of sensors. For instance, the sensor array 220 optionally includes one or more of a first sensor cluster/array 201, a second sensor cluster/array 202, a third sensor cluster/array 203, . . . , and an n^{th} sensor cluster/array 209, where n is a positive integer greater than 1, 2, 3, 4, 5, 10, 15.

Referring now to FIG. 5B, the sensor array 220 optionally and preferably includes one or more sensor types 240, such as one or more of: an accelerometer 241, a camera 242, a temperature sensor 243, a pressure sensor 244, an anemometer 245, an acoustic sensor 246, a barometer 247, and eddy current sensor 248, a guided wave sensor 249, an inclinometer 251, a pH sensor 252, a pressure sensor 253, a salinity sensor 254, a halinity sensor 255, an ultrasonic sensor 256, and/or a light sensor 257, such as a light intensity sensor and/or a camera, as described supra. For example, an instrument cluster attached directly/indirectly to a bollard optionally includes one or more of: an accelerometer to measure localized movement of the bollard at the known location; an inclinometer to measure tilt of the bollard; a temperature monitor; a water current sensor; a fog sensor, such as a camera; an anemometer, such as for measuring wind speed/wind pressure; a barometer for measuring atmospheric pressure; a salinity sensor; and/or a light sensor, where the sensor cluster is attached to a power supply, such as from the power sources 120. The accelerometer is optionally an preferably configured to measure a change in velocity of an associated bollard to which it is attached, which additionally yields vibrational information. An optional force meter is configured to measure an applied force to the first bollard.

Referring now to FIG. 5C, the sensor array 220 optionally and preferably includes an array of sensor clusters. Any 2, 3, 4, or more sensors positioned together in a container is referred to as a sensor cluster herein. For instance, when two or more sensors are co-positioned as a member of the first set of sensors 220 or bollard sensors, the co-positioned sensors are an example of a first sensor cluster 261 mounted to a bollard, such as an aquatic bollard 271. Similarly, when two or more sensors are co-positioned as a member of the second set of sensors 220 or bollard positioned sensors, the co-positioned sensors are an example of a second sensor cluster 262 mounted to an individual bollard, such as a dock bollard 272. An example of a third sensor cluster 263 is a weather station 273, which includes any two or more of the sensor types 240 when used to measure weather and/or the impact of weather on the port facility.

### Communications

Referring now to FIG. 6, the communication system 200 is further described. Here, the wireless communication system 650 is further described. The wireless communication system 650 optionally includes a base station 610, such as housing a version of the main controller 110; the main controller 110 is optionally located anywhere, such as in/on a tower 620, such as housing a data collector/transceiver 630 communicatively linked with the main controller 110 and the sub-communication systems 203 sending receiving first optional communications 652. A satellite 640 is optionally used to relay second optional communications 653 as part of a communication line from sensors of the monitoring system to the main controller 110.

Referring now to FIG. 7, monitoring areas, as opposed to individual bollards, and communications between bollards is described. As illustrated, the sensor arrays 220 on an individual bollard are optionally repeated on any number of bollards, which brings a benefit of adding information about the larger shipping center facility covered by the bollards/sensors.

Optionally, data, such as weather data, along with location of source of the data is provided, optionally for a fee, to a weather service.

Referring again to FIG. 1, the main controller 110 is further described. The main controller 110, having received localized state of the weather and/or state of the bollards from the sensor arrays 220 is optionally and preferably used to provide summary information for decision making about the state of the shipping center at any monitored location and/or between monitored locations by differential signals. Several non-limiting examples follow.

### Example I

A monitoring device is mounted to a bollard or a conductor that monitors the motion of that conductor. If and when that motion is large enough either in amplitude or frequency to cause concern based on a pre-determined metric, an action will be taken. For instance, the action is optionally to fix/maintain/replace the bollard in advance of a fault, depending on the severity of the data and thus provides capability to react proactively before an unintended fault or catastrophic failure. In another case, localized weather information is provided to local ships. In yet another case, localized collected weather information is used to shut down a port and/or shut down a region of the port.

### Example II

A monitor device package including a motion sensor is affixed to the bollard. As the bollard moves the device measures and optionally records this motion. Recording is optionally continuous and/or is triggered, such as via motion amplitude, motion frequency, a fixed offset to an initial parameter, such as an initial static angle change related to some secondary final angle.

### Example III

The monitor device package optionally includes a global positioning sensor.

### Example IV

The monitor device package optionally and preferably includes a power source. This power source may be one or more of the following: battery, solar powered, wind powered, parasitically powered (i.e. couples energy from the power conductor it is mounted to). Power sources optionally work together, such as a solar array and a battery for low/no sun times, a parasitic power source, and a battery to be used should the power be shut off intentionally or by accident or damage.

### Example V

This monitor device package optionally communicates with a fixed or relatively fixed object, such as a station on a support tower. This fixed object may be close by (possibly WiFi range˜100 m) or may be fairly far away (LoRa range>10 km). The monitor device may be able to communicate at multiple distances via one or more communication method.

### Example VI

The monitor device package optionally communicates with additional devices having different metrology. For example, a monitor device package on a bollard might communicate with a weather station mounted on an adjacent or nearby bollard and/or tower. The weather station might include any or all of the following: a temperature sensor(s), an anemometer, a wind direction indicator, a barometer, a current monitor, a fog monitor, a rainfall monitor, a hygrometer, a precipitation measurement device. Any, all or a combination of these measurements might be used as a trigger for the monitor device package to record or transmit data. As an example, if the wind speed were measured at over 10, 20, 30, 40, 50, 60, 80, or 100 mph the monitor device package is optionally triggered to record data and send it to a data collection and storage device.

### Example VII

The monitor device package optionally receives data from an external source, either directly or indirectly through a fixed mounted device or another monitor device package. For example, the monitor device package might receive information from a local meteorological station, a seismic station, and/or based on some information available on the world wide web. These received data may be used to trigger the monitor device package to record and or transmit data, or to do something else like reboot, start a measurement, activate a different piece of metrology, turn on a camera, reposition a camera, etc.

### Example VIII

The spatial distribution of the sensors in the sensor array 220 is optionally a function of local population density, historical wind speeds, shipping volume, and/or proximity of high value systems.

### Example IX

A signal from the first set of sensors on a first bollard is optionally used to control timing of collection of data from the second set of sensors mounted to the other bollards.

### Example X

In yet another example, data from the sensor array is used to reconstruct an accident, such as an order that kinetic events were observed on a set of bollards. For instance, this marks the path of a tsunami, an out of control ship, or even a squall.

### Example XI

In another example, sensors on the bollards, such as an accelerometer and/or camera are optionally used to monitor the speed of local boat/ship traffic and in real time send out warnings, instructions, and/or a fine. Similarly, the accelerometers are optionally used to monitor/report building of excessive waves, such as leading to an excessive tide or surge, or even to monitor an adverse flow of water, such as preceding a tsunami, an thus be able to send out an immediate tsunami warning.

### Example XII

In another example, the inclinometer is used to give an alarm/maintenance alert for a bollard that is excessively tilted, such as greater than 1, 2, 3, 5, 7, 10, 12, 15, or 20 degrees, indicative of wear and tear on the bollard and/or an excessive hit by a ship.

### Example XIII

In another example, an infrared camera, such as operating from 700 to 1100 nm, 700 to 2500 nm, and/or at wavelengths larger than 1100 nm, is used to see through fog and to provide those images to passing/anchored vessels.

### Example XIV

In another example, an apparatus and method of use thereof for measuring state of a shipping center is described, the shipping center comprising a body of water and a set of bollards positioned in the water, the apparatus comprising: a main controller and a sensor array communicatively linked to the main controller, the sensor array comprising: a set of at least fifty sensor clusters, individual members of the set of at least fifty sensor clusters respectively mounted on a set of at least fifty bollards of the set of bollards, wherein each member of the set of at least fifty bollards comprises separate water surrounded positions in the shipping center, the shipping center comprising a radius of less than one hundred miles, the sensor cluster comprising: an inclinometer, an accelerometer, a water current sensor, a camera, a temperature sensor, and/or an anemometer.

Still yet another embodiment includes any combination and/or permutation of any of the elements described herein.

Herein, any number, such as 1, 2, 3, 4, 5, is optionally more than the number, less than the number, or within 1, 2, 5, 10, 20, or 50 percent of the number.

The particular implementations shown and described are illustrative of the invention and its best mode and are not intended to otherwise limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or physical couplings between the various elements. Many alternative or additional functional relationships or physical connections may be present in a practical system.

In the foregoing description, the invention has been described with reference to specific exemplary embodiments; however, it will be appreciated that various modifications and changes may be made without departing from the scope of the present invention as set forth herein. The description and figures are to be regarded in an illustrative manner, rather than a restrictive one and all such modifications are intended to be included within the scope of the present invention. Accordingly, the scope of the invention should be determined by the generic embodiments described herein and their legal equivalents rather than by merely the specific examples described above. For example, the steps recited in any method or process embodiment may be executed in any order and are not limited to the explicit order presented in the specific examples. Additionally, the components and/or elements recited in any apparatus embodiment may be assembled or otherwise operationally configured in a variety of permutations to produce substantially the same result as the present invention and are accordingly not limited to the specific configuration recited in the specific examples.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components.

As used herein, the terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

Although the invention has been described herein with reference to certain preferred embodiments, one skilled in the art will readily appreciate that other applications may be substituted for those set forth herein without departing from the spirit and scope of the present invention. Accordingly, the invention should only be limited by the Claims included below.

1. An apparatus for measuring state of a shipping center, the shipping center comprising a body of water and a set of bollards positioned in the water, said apparatus comprising:
a main controller; and
a sensor array communicatively linked to said main controller, said sensor array comprising:
a first cluster of sensors attached to a first bollard of the set of bollards, said first cluster of sensors comprising sensors configured to measure state of the first bollard; and
a second cluster of sensors attached to a second bollard of the set of bollards, said second cluster of sensors comprising sensors configured to measure environmental state about the second bollard,
wherein both the first bollard and the second bollard comprise positions in the body of water with water on all lateral sides.

2. The apparatus of claim 1, said first cluster of sensors comprising at least one of:
an inclinometer configured to measure a change in an angle of orientation of the first bollard;
a force meter configured to measure an applied force to the first bollard; and
an accelerometer configured to measure change in velocity of the first bollard.

3. The apparatus of claim 2, said first cluster of sensors comprising both said inclinometer and said accelerometer.

4. The apparatus of claim 2, said first cluster of sensors comprising:
a camera.

5. The apparatus of claim 3, said camera further comprising:
a near-infrared detector.

6. The apparatus of claim 2, said second cluster of sensors comprising at least two of:
a temperature sensor;
an anemometer;
a barometer; and
a water current sensor.

7. The apparatus of claim 2, said second cluster of sensors comprising:
a water current sensor.

8. The apparatus of claim 6, further comprising:
direct communicative coupling between said first cluster of sensors and said second cluster of sensors.

9. The apparatus of claim 6, further comprising:
a remote sub-communication system positioned within five thousand feet of the a first sub-communication cluster communicatively linked to said first cluster of sensors, said first sub-communication system configured to relay data from at least said first cluster of sensors to said main controller via said remote sub-communication system.

10. The apparatus of claim 9, further comprising:
a second sub-communication system communicatively linked to said first sub-communication system, said second sub-communication system configured to relay data from said second cluster of sensors to said first sub-communication system, the second bollard positioned at least two hundred feet from the first bollard.

11. The apparatus of claim 6, further comprising:
known locations of elements of said sensor array, said known locations spanning a distance of greater than one-quarter mile and less than ten miles.

12. The apparatus of claim 1, said main controller configured to gather weather related data from said sensor array.

13. The apparatus of claim 1, said sensor array further comprising:
a set of at least fifty sensor clusters, individual members of said set of at least fifty sensor clusters respectively mounted on a set of at least fifty bollards of the set of bollards, wherein each member of the set of at least fifty bollards comprises separate water surrounded positions in the shipping center, the shipping center comprising a radius of less than one hundred miles.

14. An apparatus for measuring state of a shipping center, the shipping center comprising a body of water and a set of bollards positioned in the water, said apparatus comprising:
a main controller; and
a sensor array communicatively linked to said main controller, said sensor array comprising:
a set of at least fifty sensor clusters, individual members of said set of at least fifty sensor clusters respectively mounted on a set of at least fifty bollards of the set of bollards, wherein each member of the set of at least fifty bollards comprises separate water surrounded positions in the shipping center, the shipping center comprising a radius of less than one hundred miles.

15. The apparatus of claim 1, said set of at least fifty sensor clusters further comprising:
a first sensor cluster comprising at least four of:
an inclinometer;
an accelerometer configured to sense motion of a first bollard of the set of bollards;
a water current sensor;
a camera;
a temperature sensor; and
an anemometer.
